(19) United States
(12) Patent Application Publication
(10) Pub. No.: US 2010/0129113 A1
(43) Pub. Date: May 27, 2010

(54) IMAGE FORMING APPARATUS

(76) Inventors: Atsushi Sampe, Kanagawa-ken (JP); Yoshiyuki Kimura, Tokyo-to (JP); Hiroshi Hosokawa, Kanagawa-ken (JP); Hiroyuki Nagashima, Kanagawa-ken (JP); Nobuo Kuwabara, Kanagawa-ken (JP); Wakako Murakami, Tokyo-to (JP); Hideki Zemba, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/683,964

(22) Filed: Jan. 7, 2010

Related U.S. Application Data
(62) Division of application No. 11/178,286, filed on Jul. 12, 2005.

(30) Foreign Application Priority Data
Jul. 12, 2004 (JP) 2004-204329

(51) Int. Cl. G03G 21/16

(52) U.S. Cl. 399/111

(57) ABSTRACT

An image forming apparatus includes an endless transfer member and a plurality of image forming units. The endless transfer member is arranged at a transverse position in the image forming apparatus, and has a circulatory rotating surface declining at a predetermined angle to a horizontal plane. Each of the plurality of image forming units includes a first surface facing the endless transfer member and a second surface opposite to the first surface and angled in a similar direction to the endless transfer member. The plurality of image forming units perform an image forming operation and are arranged next to one another facing the endless transfer member such that, in any two adjacent image forming units of the plurality of image forming units, one of the any two adjacent image forming units has a portion overhanging the other one of the any two adjacent image forming units.

### CROSS REFERENCE TO RELATED APPLICATION

This application is a divisional of U.S. application Ser. No. 11/178,286, filed on Jul. 12, 2005, and is based upon and claims the benefit of priority from the prior Japanese Patent Application No. 2004-204329 filed on Jul. 12, 2004, the entire contents of each of which are incorporated herein by reference.

### BACKGROUND OF THE INVENTION

1. Field of the Invention

This patent specification relates to an image forming apparatus.

2. Discussion of the Background Arts

A background color image forming apparatus is provided with an intermediate transfer belt in addition to a plurality of color image forming devices. Such an intermediate transfer belt is arranged above the plurality of color image forming devices, and is driven to rotate in order to have a moving surface thereof in contact with the plurality of color image forming devices. In this structure, the intermediate transfer belt superimposes separate color images prepared by the plurality of color image forming devices into a single color image. Because of the presence of such an intermediate transfer belt, the background color image forming apparatus has a relatively large size.

In a typical case, the intermediate transfer belt has upper and lower moving surfaces angled to have the lower moving surface tilted downward in a direction toward a downstream side of a rotation direction of the intermediate transfer belt. As a result, the plurality of color image forming devices which are juxtaposed along and under the lower moving surface of the intermediate transfer belt are also angled downward. The background image forming apparatus as described above is described in Japanese Laid-Open Patent Publication Nos. 2003-202728, 2003-316107, 2004-53818, and 2004-29057, for example.

Accordingly, an image forming apparatus using less space than the background color image forming apparatus having the tilted intermediate transfer belt is desired.

### SUMMARY OF THE INVENTION

One aspect of the present invention includes an image forming apparatus. In one example, an image forming apparatus includes an endless transfer member and a plurality of image forming units. The endless transfer member is configured to be arranged at a transverse position in the image forming apparatus and have a circulatory rotating surface declining at a predetermined angle to a horizontal plane. Each of the plurality of image forming units includes a first surface facing the endless transfer member and a second surface opposite to the first surface and angled in a similar direction to the endless transfer member. The plurality of image forming units are configured to perform an image forming operation and arranged next to one another facing the endless transfer member such that, in any two adjacent image forming units of the plurality of image forming units, one of the any two adjacent image forming units has a portion overhanging the other one of the any two adjacent image forming units.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a vertical sectional view of a full-color image forming apparatus according to an embodiment of the present invention;

FIG. 2 is an enlarged view of image carrying members shown in FIG. 1 and image forming devices which form toner images on surfaces of the image carrying members;

FIG. 3 is a sectional view of process cartridges provided in an alternative embodiment of a tandem-type image forming apparatus;

FIG. 4 is a sectional view of a process cartridge according to an embodiment of the present invention, as placed on a horizontal plane;

FIG. 5 is a sectional view of the process cartridge shown in FIG. 4, as placed in the image forming apparatus shown in FIG. 1;

FIG. 6 is a sectional view of an intermediate transfer belt and process cartridges placed in the image forming apparatus shown in FIG. 1, as viewed from a front side;

FIG. 7 is a sectional view of the image forming apparatus shown in FIG. 6, with the process cartridges removed;

FIG. 8 is an enlarged view of relevant parts of the image forming apparatus shown in FIG. 7;

FIG. 9 is a perspective view of the process cartridge shown in FIG. 4;

FIG. 10 is a sectional view of relevant parts of the process cartridge shown in FIG. 9 placed in the image forming apparatus shown in FIG. 1, as viewed from a front side;

FIG. 11 is a perspective view of relevant parts of the process cartridge shown FIG. 9 placed in the image forming apparatus shown in FIG. 1;

FIG. 12 is a perspective view of relevant parts of the process cartridge shown in FIG. 9, wherein a lever of the process cartridge is pulled out for use.

### DETAILED DESCRIPTION OF THE INVENTION

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner.

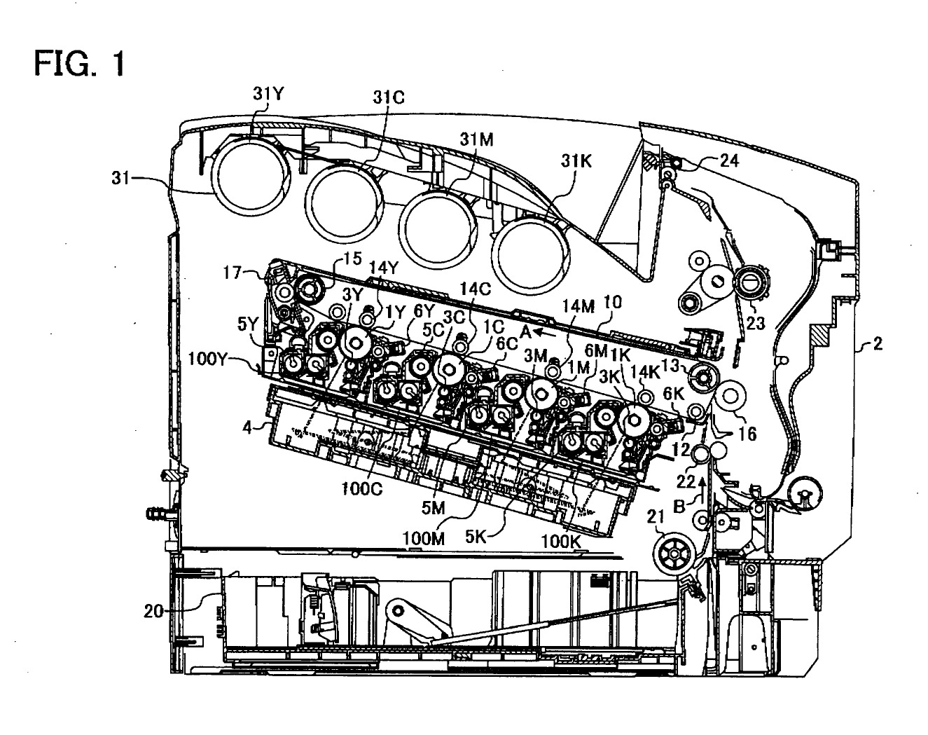

Referring now to the drawings, wherein like reference numerals designate identical or corresponding parts throughout the several views, particularly to FIG. 1, an image forming apparatus 2 according to an embodiment of the present invention is described.

The image forming apparatus 2 illustrated in FIG. 1 is a full-color image forming apparatus according to an embodiment of the present invention. The image forming apparatus 2 includes toner bottles 31Y, 31C, 31M, and 31K, an ejection roller pair 24, a fixing device 23, an intermediate transfer belt 10, first transfer rollers 14Y, 14C, 14M, and 14K, support rollers 12, 13, and 15, a second transfer roller 16, a belt cleaning device 17, process cartridges 100Y, 100C, 100M, and 100K, an optical writing device 4, a registration roller pair 22, a sheet-feeding cassette 20, and a sheet-feeding roller 21. Each of the process cartridges 100Y, 100C, 100M, and 100K includes a corresponding one of image carrying members 1Y, 1C, 1M, and 1K, charging devices 3Y, 3C, 3M, and 3K, development devices 5Y, 5C, 5M, and 5K, and cleaning devices 6Y, 6C, 6M, and 6K. The process cartridges 100Y, 100C, 100M, and 100K are detachably provided in the image forming apparatus 2.

The process cartridges 100Y, 100C, 100M, and 100K form yellow toner images, cyan toner images, magenta toner images, and black toner images, respectively. In the present embodiment, the image carrying members 1Y, 1C, 1M, and 1K are drum-shaped photoconductors. The charging devices 3Y, 3C, 3M, and 3K uniformly charge surfaces of the corresponding image carrying members 1Y, 1C, 1M, and 1K. The development devices 5Y, 5C, 5M, and 5K supply toner to the thus charged surfaces of the image carrying members 1Y, 1C, 1M, and 1K, and develop latent images formed by the optical writing device 4 on the surfaces of the image carrying members 1Y, 1C, 1M, and 1K. The cleaning devices 6Y, 6C, 6M, and 6K coat the surfaces of the image carrying members 1Y, 1C, 1M, and 1K with lubricant and collect waste toner from the surfaces of the image carrying members 1Y, 1C, 1M, and 1K. The process cartridges 100Y, 100C, 100M, and 100K are configured to be attached to and detached from the image forming apparatus 2.

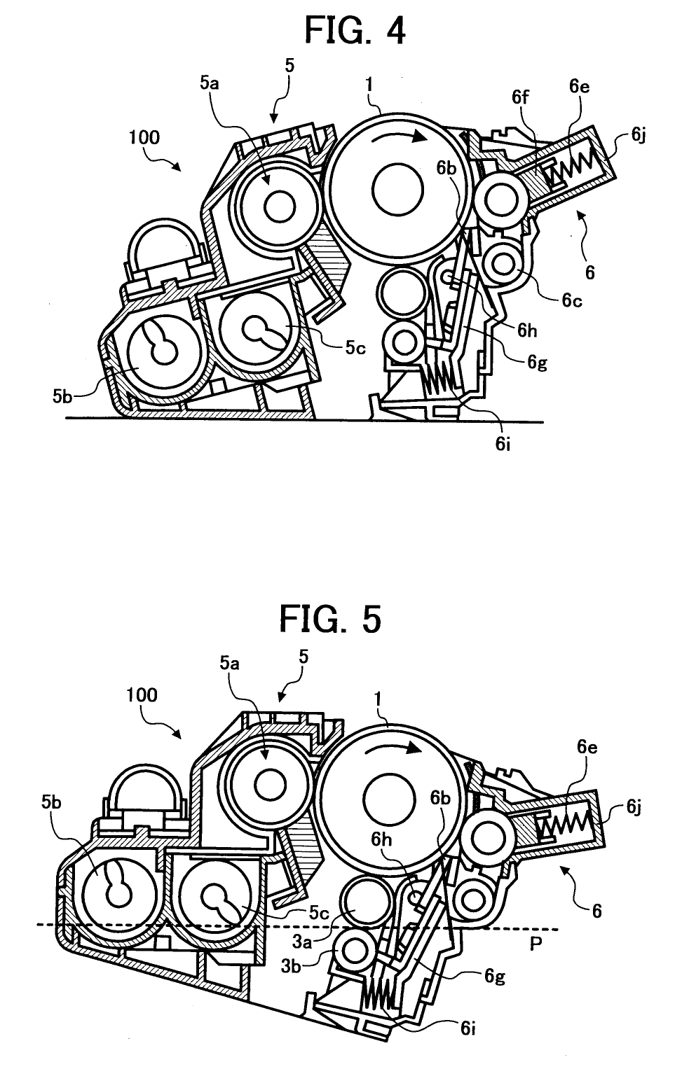

In the process cartridges 100Y, 100C, 100M, and 100K, toner images are formed on the image carrying members 1Y, 1C, 1M, and 1K, respectively, and transferred to a surface of the intermediate transfer belt 10. The process cartridges 100Y, 100C, 100M, and 100K form toner images of different colors but are substantially similar in structure. Therefore, in the following description of a process cartridge where distinction of toner colors is not necessary, the process cartridge is generally referred to as the process cartridge 100 (for example, in FIGS. 4 and 5). Similarly, a component member and a supporting member of the process cartridge 100 is referred to by a number without a suffix of Y, C, M or K in a description where the distinction of toner colors is not necessary, and is referred to by a number with the suffix Y, C, M or K where such distinction is necessary. For example, an image carrying member and a development device are referred to as an image carrying member 1 and a development device 5, respectively, instead of the image carrying member 1Y, 1C, 1M, or 1K and the development device 5Y, 5C, 5M, or 5K, in the following description where the distinction of toner colors is not necessary.

The intermediate transfer belt 10 is endless, i.e., formed into a loop, and temporarily carries the toner image developed on the surface of the image carrying member 1. The intermediate transfer belt 10 passes over the support rollers 12, 13, and 15 and is driven to rotate in a direction indicated by an arrow “A” shown in FIG. 1. The process cartridges 100Y, 100C, 100M, and 100K are provided in juxtaposition with one another in the image forming apparatus 2. The intermediate transfer belt 10 is located above the process cartridges 100Y, 100C, 100M, and 100K. A lower surface of the intermediate transfer belt 10 sequentially comes in contact with the surfaces of the image carrying members 1Y, 1C, 1M, and 1K in a moving direction of the intermediate transfer belt 10. The support rollers 12 and 13 are provided in the vicinity of the image carrying member 1K, while the support roller 15 is provided in the vicinity of the image carrying member 1Y. Further, the support roller 15 is positioned at a higher level than the support rollers 12 and 13, and the intermediate transfer belt 10 is angled. In the present embodiment, therefore, the process cartridges 100Y, 100C, 100M, and 100K are sequentially arranged in a descending order in a space between the support roller 15 and the support roller 12 along the lower surface of the intermediate transfer belt 10.

In the space between the support roller 15 and the support roller 12 along the lower surface of the intermediate transfer belt 10, the first transfer rollers 14Y, 14C, 14M, and 14K are provided along an inside surface of the intermediate transfer belt 10 to contact the image carrying members 1Y, 1C, 1M, and 1K, respectively, through the intermediate transfer belt 10. The optical writing device 4 is provided under the process cartridges 100Y, 100C, 100M, and 100K.

In a lower part of the image forming apparatus 2, the sheet-feeding cassette 20 and the sheet-feeding roller 21 are provided. The sheet-feeding cassette 20 and the sheet-feeding roller 21 form a sheet-feeding device. The sheet-feeding cassette 20 stores sheets of a recording medium which may be a transfer paper, for example. The registration roller pair 22 is provided at a downstream position of the sheet-feeding roller 21 in a direction of sheet-feeding performed by the sheet-feeding roller 21. The second transfer roller 16 is provided to contact the support roller 13 through the intermediate transfer belt 10. The fixing device 23 is provided at a downstream position of the second transfer roller 16.

In an upper part of the image forming apparatus 2, the toner bottles 31Y, 31C, 31M, and 31K are replaceably provided. The toner bottles 31Y, 31C, 31M, and 31K are filled with toner of the respective colors. The toner of the respective colors are conveyed from the toner bottles 31Y, 31C, 31M, and 31K through conveying paths (not illustrated) to the development devices 5Y, 5C, 5M, and 5K included in the respective process cartridges 100Y, 100C, 100M, and 100K.

When toner of a particular color runs out, the toner bottle 31 which contains the toner is replaced with a new toner bottle, replenishing the toner supply. Similarly, the process cartridge 100 is replaced with a new process cartridge when the process cartridge 100 needs to be replaced.

In the image forming apparatus 2 illustrated in FIG. 1, the toner bottles 31Y, 31C, 31M, and 31K are provided in the upper part of the image forming apparatus 2, and the toner of the respective colors is conveyed to the process cartridges 100Y, 100C, 100M, and 100K for toner replenishment. With this configuration, replacement of other components than a toner bottle 31 is usually unnecessary when toner in the toner bottle 31 runs out. Accordingly, expenses for users of the image forming apparatus 2 can be reduced. Further, with this configuration, other parts than the toner bottle 31 provided in the image forming apparatus 2 are relatively infrequently opened and closed or pulled out from and pushed into the image forming apparatus 2. Therefore, toner scattering occurring at a shutter (not illustrated), for example, can be prevented. As a result, maintenance of the image forming apparatus 2 can be improved.

The toner images formed on the process cartridges 100Y, 100C, 100M, and 100K are sequentially superimposed on and transferred to the intermediate transfer belt 10 in a first transfer operation. Accordingly, a composite toner image is formed on the intermediate transfer belt 10.

Meanwhile, as the sheet-feeding roller 21 rotates, a top one of the sheets of the recording medium stored in the sheet-feeding cassette 20 is conveyed in a direction indicated by an arrow “B” shown in FIG. 1. The recording medium is further conveyed by the registration roller pair 22 at a predetermined time toward a nip formed between a part of the intermediate transfer belt 10 passing over the support roller 13 and the second transfer roller 16 provided to face the support roller 13. In this process, the second transfer roller 16 is applied with a predetermined transfer voltage. As a result, the composite toner image formed on the intermediate transfer belt 10 is transferred to the recording medium in a second transfer operation.

The recording medium to which the composite toner has been transferred is further conveyed upward into the fixing device 23. In the fixing device 23, heat and pressure are applied to the recording medium and the composite toner image is fixed on the recording medium. After passing through the fixing device 23, the recording medium is discharged to an ejection area in the upper part of the image forming apparatus 2. After the composite toner image has been transferred from the intermediate transfer belt 10 to the recording medium, remaining toner adhered to the intermediate transfer belt 10 is removed by the belt cleaning device 17.

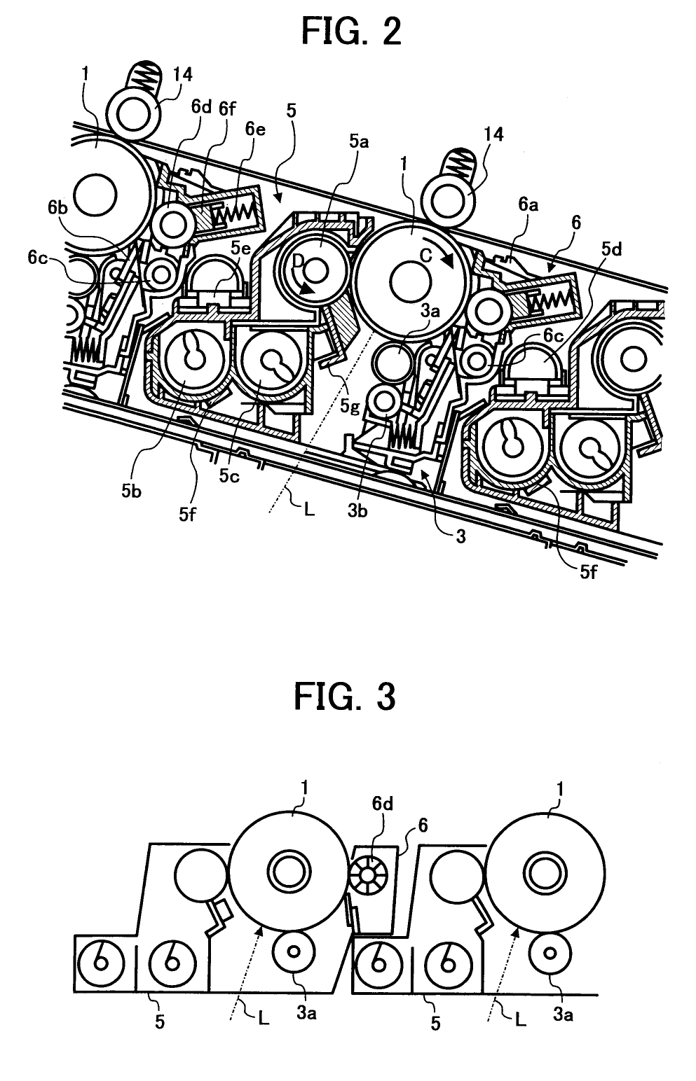

FIG. 2 illustrates an enlarged view of the image carrying member 1 and the image forming devices used for forming a toner image on the surface of the image carrying member 1. The charging device 3 includes a charging roller 3a and a charging roller cleaner 3b. The development device 5 includes a development roller 5a, mixing members 5b and 5c, a protruding portion 5d, a toner replenishing port 5e, a sensor 5f, and a development blade 5g. The cleaning device 6 includes a cleaning case 6a, a cleaning blade 6b, a waste toner conveying screw 6c, a brush roller 6d, a spring 6e, and a lubricant 6f.

The image carrying member 1 is driven to rotate in a clockwise direction indicated by an arrow “C” in FIG. 2. The image carrying member 1 is charged to a predetermined polarity by the charging device 3 which includes the charging roller 3a provided at a charging voltage. The image carrying member 1 thus charged is irradiated with a light-modulated writing beam emitted from the optical writing device 4 shown in FIG. 1 along a light path L shown in FIG. 2. Accordingly, an electrostatic latent image is formed on the surface of the image carrying member 1. The electrostatic latent image is developed into a visible toner image by the development device 5.

Configurations of the development device 5 and the cleaning device 6 are described with reference to FIG. 2.

In the development device 5, the development roller 5a includes a magnetized and fixed magnet roller and an aluminum sleeve. The magnet roller forms an inside part of the development roller 5a, while the sleeve forms an outside part of the development roller 5a. When the electrostatic latent image formed on the image carrying member 1 is developed, the development roller 5a is driven to rotate by a gear (not illustrated) in a direction inverse to the rotation direction of the image carrying member 1 at a linear velocity 2.5 times greater than a linear velocity of the image carrying member 1. The mixing members 5b and 5c are toner conveying screws. The protruding portion 5d is dome-shaped and provided with the toner replenishing port 5e which communicates with the mixing member 5b. With this configuration, toner is supplied to the toner replenishing port 5e from a toner bottle at a backside of the image forming apparatus 2 through a toner conveying coil (not illustrated), a toner conveying pipe (not illustrated), and the protruding portion 5d. Then, the mixing members 5b mix development carrier and toner and convey them from a backside to a front side in the figure. The respective development devices 5Y, 5C, 5M, and 5K store the development carrier in advance. The toner is conveyed and mixed with the development carrier so that the toner is charged. The toner is then conveyed by the mixing member 5c from the front side to the backside in the figure, suctioned up to the sleeve by a magnetic force of the development roller 5a, spread into a thin layer by the development blade 5g, and conveyed to a nip formed between the development roller 5a and the image carrying member 1. Then, the electrostatic latent image formed on the image carrying member 1 is developed into the toner image.

In this process, the image carrying member 1 rotates in the direction indicated by the arrow “C,” while the sleeve of the development roller 5a rotates in a direction indicated by an arrow “D” shown in FIG. 2. These rotation directions help the development roller 5a to suction the toner upward in a vertical direction, preventing the toner from dropping downward.

The developed toner image reaches a nip formed between the image carrying member 1 and the intermediate transfer belt 10 and is transferred to the surface of the intermediate transfer belt 10. Toner remaining on the surface of the image carrying member 1 without having been transferred to the surface of the intermediate transfer belt 10 is collected by the cleaning device 6.

In the cleaning device 6, the cleaning case 6a has an opening facing the image carrying member 1. The cleaning blade 6b has a base end fastened to and supported by the cleaning case 6a, and a leading end pressed against the surface of the image carrying member 1. Further, a 2 mm-thick blade sheet made of urethane rubber, for example, is bonded and fixed to the cleaning blade 6b (illustrated in FIG. 4). The cleaning blade 6b thus configured is used for removing toner remaining on the surface of the image carrying member 1. The waste toner conveying screw 6c conveys the removed toner to a waste toner bottle (not illustrated). In FIG. 2, the brush roller 6d contacts the surface of the image carrying member 1 at a higher position than a contact position of the cleaning blade 6b and the image carrying member 1. The lubricant 6f contacts the brush roller 6d. The spring 6e presses the lubricant 6f toward the brush roller 6d.

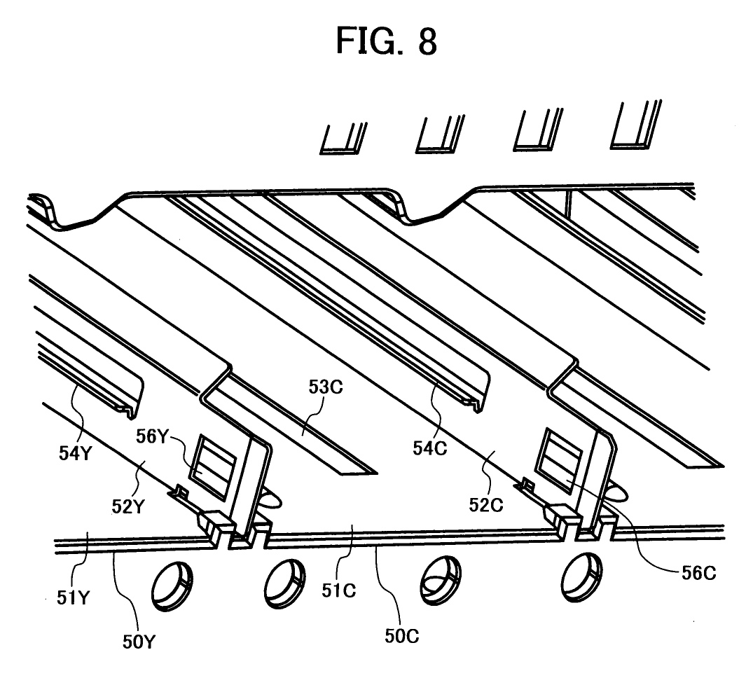

As illustrated in FIG. 2, the cleaning device 6 is provided at a lower position than the development device 5 and the image carrying member 1 along a slope shown in the figure. This configuration is intended for conveying waste toner in the cleaning device 6 by using the waste toner conveying screw 6c, such that the waste toner is kept as far way from the image carrying member 1 and the charging roller 3a as possible. With this configuration, even if the waste toner drops to the outside of the cleaning device 6, the dropped waste toner stays in a corner of a rail 54 (illustrated in FIG. 8) provided in the image forming apparatus 2, and does not drop into the optical writing device 4 through slits formed on the optical writing device 4. As a result, a defect in an image caused by dropped waste toner can be prevented.

Generally, if influence of AC (alternating current) discharge on the charging roller 3 increases, such components as wax and additives contained in the toner tend to form a film on the surface of the image carrying member 1. Further, corona products formed by a discharge tend to adhere to the surface of the image carrying member 1 and cause image deletion. Furthermore, if a friction coefficient of a photoconductor becomes unstable under a certain environmental condition, blade cleaning may not be appropriately performed. In light of this, an attempt to actively coat the surface of the image carrying member 1 with lubricant such as zinc stearate and calcium stearate has been made to stabilize cleaning performance of a cleaning device and extend a lifetime of the photoconductor. A typical small-size, tandem-type image forming apparatus, however, does not have enough space for storing lubricant of a sufficient amount lasting until the end of the life of the process cartridge and a system for coating the lubricant. Therefore, it is difficult to extend the lifetime of the process cartridge in this small-size, tandem-type image forming apparatus.

FIG. 3 illustrates a sectional view of process cartridges used in an alternative embodiment of a tandem-type image forming apparatus. A detailed description is omitted for components shown in FIG. 3 which are similar in function to the components shown in FIG. 2 and thus assigned with the same reference numbers. In the configuration illustrated in FIG. 3, the process cartridges are arranged in the horizontal plane. In this case, dropped or scattered waste toner can relatively easily adhere to the surface of the charging roller 3a and block the light paths through which the writing beams emitted from the optical writing device 4 pass. Further, this alternative tandem-type image forming apparatus does not have enough space for storing a sufficient amount of lubricant and a system for coating the image carrying member 1 with the lubricant.

According to the present embodiment, a plane connecting the axes of the image carrying members 1Y, 1C, 1M, and 1K is angled by fifteen degrees to the horizontal plane, as illustrated in FIG. 1. Further, lower surfaces of the process cartridges 100Y, 100C, 100M, and 100K and the intermediate transfer belt 10 are arranged in parallel with the angled plane. Thus configured, a development device 5 included in a process cartridge 100 and a cleaning device 6 included in an adjacent process cartridge 100 can be effectively arranged vertically. For example, in FIG. 1, the process cartridges 100Y and 100C partially overlap with each other, i.e., the development device 5C and the cleaning device 6Y overlap with each other. As a result, the lubricant 6f of a sufficient amount lasting until the end of the life of the process cartridge 100 can be stored in each of the development devices 5 provided in the image forming apparatus 2.

For example, if an image forming apparatus for A4-sized recording sheets includes development devices each including the lubricant 6f made of an 8*8*236 mm-sized zinc stearate bar, each of the process cartridges included in the image forming apparatus can be used for printing more than a hundred thousand pages. Further, the brush roller 6d used in the present embodiment is formed by a brush core connected to the ground and a brush made of an acrylic conductive resin (TORAY SA-7 6.25 D/F). Density of bristles of the brush roller 6d is 50000/inch². The lubricant 6f is pressed against the brush roller 6d with pressure in a range of 500 mN to 2000 mN. A linear velocity of the brush roller 6d is approximately 1 to 1.3 times greater than a linear velocity of the image carrying member 1. The image carrying member 1 is a 30 mm diameter organic photoconductor (OPC) and the brush roller 6d is a 12 mm diameter OPC. The brush roller 6d is pressed to contact the image carrying member 1 with a penetration depth of 1 mm, and rotates in a direction inverse to the rotation direction of the image carrying member 1.

FIG. 4 illustrates a sectional view of the process cartridge 100 according to the present embodiment, as placed on the horizontal plane. Meanwhile, FIG. 5 illustrates a sectional view of the process cartridge 100, as placed in the image forming apparatus 2 shown in FIG. 1. In the cleaning device 6 illustrated in FIGS. 4 and 5, 6g is a cleaning bracket, 6h is a support shaft, 6i is a pressure spring, and 6j is a case.

The cleaning bracket 6g is rotatably provided around the support shaft 6h. The cleaning bracket 6g has one end to which the cleaning blade 6b is fastened, and the other end is provided in contact with the pressure spring 6i. The pressure spring 6i applies biasing force to the cleaning bracket 6g such that the cleaning bracket 6g presses the image carrying member 1 with predetermined pressure.

As illustrated in FIGS. 4 and 5, the case 6j houses the lubricant 6f and the spring 6e such that the spring 6d presses and moves the lubricant 6f on the surface of the brush roller 6d. The opening of the case 6j is angled to face a waste toner collecting area in which the waste toner is collected, whether the process cartridge 100 is placed in the image forming apparatus 2 or placed in the horizontal plane. Accordingly, the waste toner and development carrier accumulated in the case 6j drop by their own weight and are discharged to the outside of the process cartridge 100 by the waste toner conveying screw 6c.

As illustrated in FIG. 4, when the process cartridge 100 is placed on the horizontal plane, the mixing member 5c, which is closer to the development roller 5a than the other mixing member 5b is to the development roller 5a, is at a higher position than the mixing member 5b. Meanwhile, as illustrated in FIG. 5, when the process cartridge 100 is placed in the image forming apparatus 2, the mixing members 5c and 5b are substantially at an equal level. Further, a space is formed under a plane connecting lower ends of the mixing members 5c and 5b, which is indicated by the plane “P” in FIG. 5. In the present embodiment, this space is used for storing the charging roller cleaner 3b which cleans the charging roller 3a, or the sensor 5f shown in FIG. 2 which detects an amount of the developer.

As illustrated in FIG. 5, when the process cartridge 100 is placed in the image forming apparatus 2, the cleaning blade 6b is approximately vertically positioned around the support shaft 6h which forms a rotation support. Further, the cleaning blade 6b is pressed by the pressure spring 6i to contact and press the image carrying member 1 with predetermined pressure. Therefore, when the process cartridge 100 is placed in the image forming apparatus 2, a direction of pressure applied by the pressure spring 6i is substantially horizontal. As a result, the influence of the weight of the cleaning bracket 6g can be ignored. Accordingly, when the process cartridge 100 is placed in the image forming apparatus 2 as illustrated in FIG. 5, the initial contact pressure of the cleaning blade 6b against the image carrying member 1 can be accurately set and maintained by considering the pressure applied by the pressure spring 6i and ignoring the influence of the weight of the cleaning bracket 6g.

As illustrated in FIG. 5, the space formed under the mixing members 5b and 5c is effectively used for storing the pressure system described above.

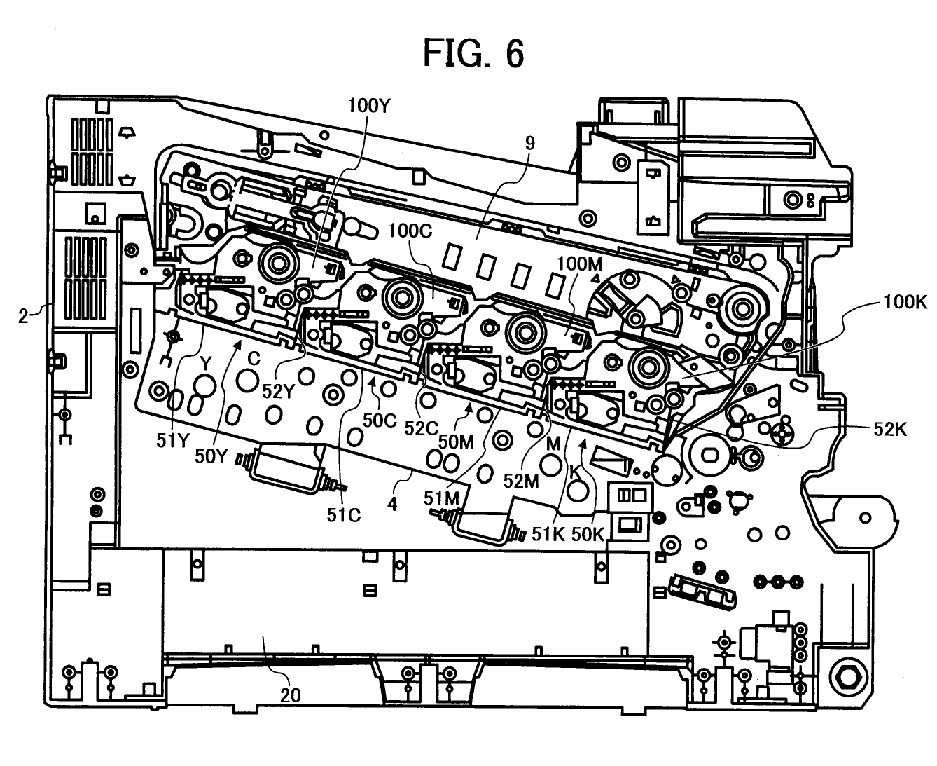

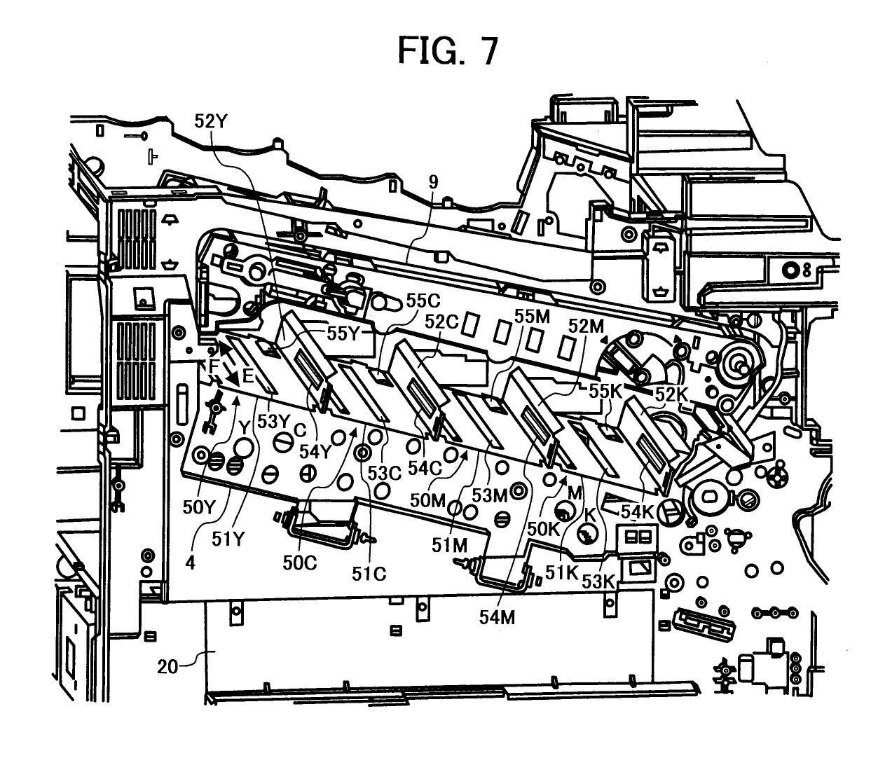

FIG. 6 illustrates an internal configuration of the image forming apparatus 2 as viewed from a front side, in which the intermediate transfer belt 10 is placed in the image forming apparatus 2. FIG. 7 illustrates an internal configuration of the image forming apparatus 2 as viewed from the front side, in which the process cartridges 100Y, 100C, 100M, and 100K are removed from the image forming apparatus 2. FIG. 8 illustrates an enlarged view of relevant parts of the image forming apparatus 2 shown in FIG. 7.

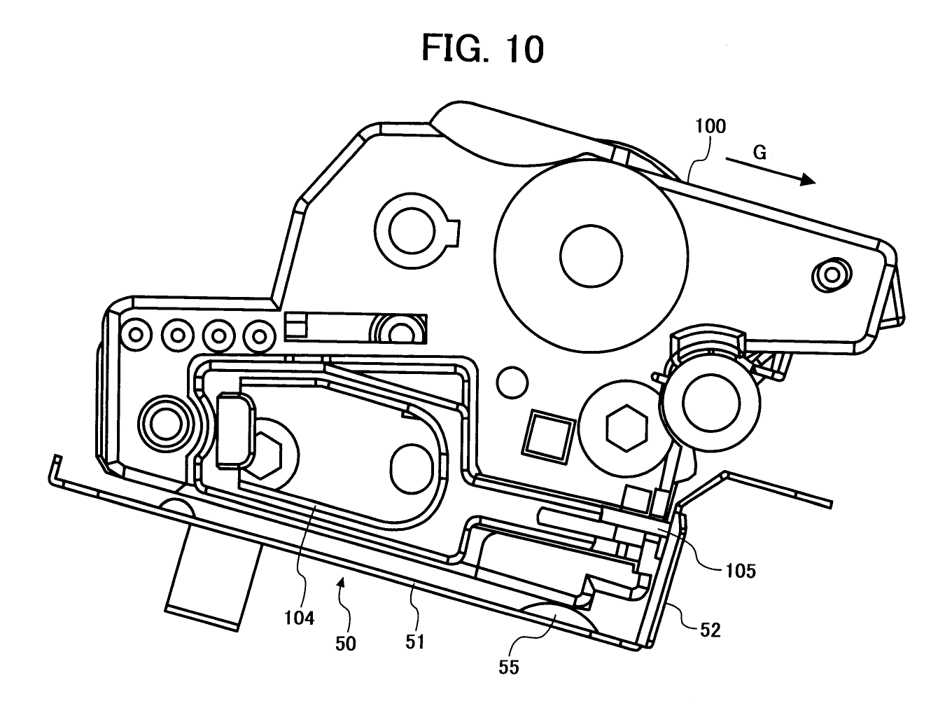

As illustrated in FIG. 6, guiding members 50Y, 50C, 50M, and 50K are immovably provided in the image forming apparatus 2. The guiding members 50Y, 50C, 50M, and 50K include support plates 51Y, 51C, 51M, and 51K, and regulation plates 52Y, 52C, 52M, and 52K, respectively. The support plate 51 (also shown in FIG. 10) underpins and guides the process cartridge 100, when the process cartridge 100 is attached to and detached from the image forming apparatus 2. The regulation plate 52 rises upward substantially perpendicular to the support plate 51. The support plates 51Y, 51C, 51M, and 51K are arranged substantially in parallel with the lower surface of the intermediate transfer belt 10 which faces the image carrying members 1Y, 1C, 1M, and 1K. In the present embodiment, the support plates 51Y, 51C, 51M, and 51K are arranged in a plane at an angle of fifteen degrees to the horizontal plane. Since a guiding surface of the support plates 51Y, 51C, 51M, and 51K which guide the respective process cartridges 100Y, 100C, 100M, and 100K are in a single plane, surfaces of the process cartridges 100Y, 100C, 100M, and 100K facing the intermediate transfer belt 10 are also in a single plane. As illustrated in FIG. 6, an intermediate transfer belt unit 9, which includes the intermediate transfer belt 10 and support rollers, is provided above the process cartridges 100Y, 100C, 100M, and 100K.

The optical writing device 4 is provided under the support plates 51Y, 51C, 51M, and 51K, i.e., on an opposite side of the guiding surface of the support plates 51Y, 51C, 51M, and 51K. The optical writing device 4 is also arranged at an angle along the plane in which the support plates 51Y, 51C, 51M, and 51K are arranged. The optical writing device 4 may be a unit in which a plurality of light sources are integrated, as illustrated in FIG. 1. Alternatively, the optical writing devices 4 may include a plurality of members each including one light source. In this case, the respective plurality of members are arranged such that surfaces of the members facing the process cartridges 100Y, 100C, 100M, and 100K are arranged at an angle along the plane in which the process cartridges 100Y, 100C, 100M, and 100K are arranged.

In FIG. 7, 53Y, 53C, 53M, and 53K indicate light passing slots, 54Y, 54C, 54M, and 54K indicate rails, and 55Y, 55C, 55M, and 55K indicate convex portions. In FIG. 8, 56Y and 56C indicate reference holes.

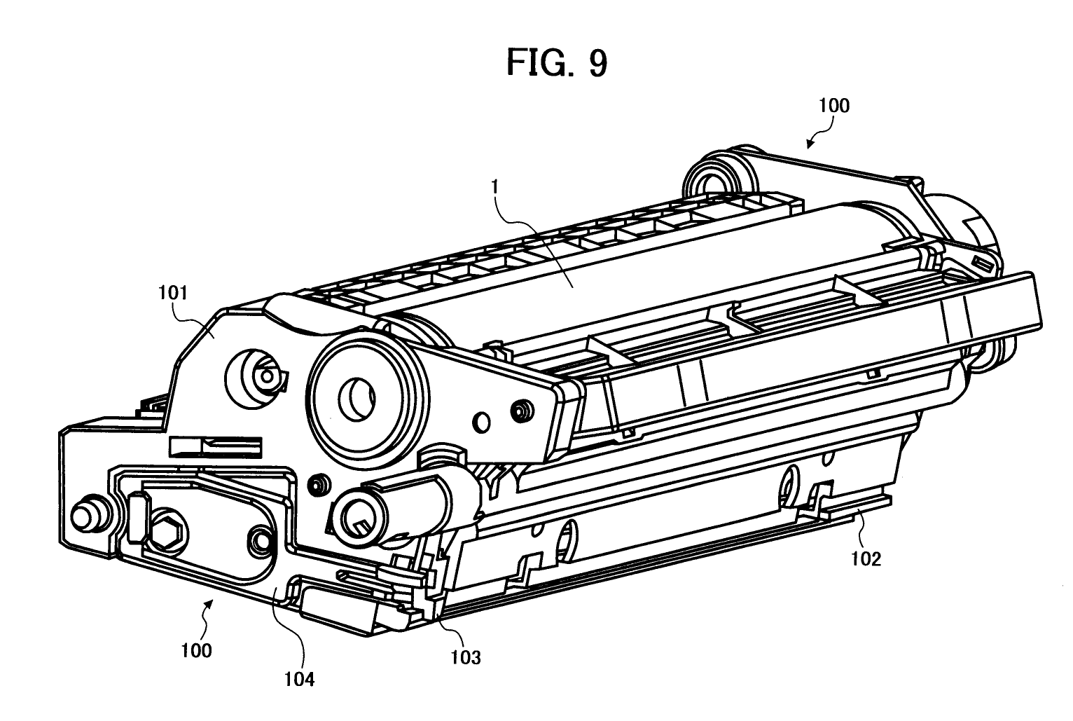

As shown in FIGS. 1 and 2, the lower surfaces of the unit cases (the unit case 101 is illustrated in FIG. 9) of the process cartridges 100Y, 100C, 100M, and 100K are angled in parallel with the support plates 51Y, 51C, 51M, and 51K. Therefore, the process cartridges 100Y, 100C, 100M, and 100K are angled in the image forming apparatus 2 as described above. In the image forming apparatus 2 thus configured, the light passing slots 53Y, 53C, 53M, and 53K are formed in the respective support plates 51Y, 51C, 51M, and 51K to allow the writing beams emitted from the optical writing device 4 to pass therethrough and on to the respective image carrying members 1Y, 1C, 1M, and 1K. Although not illustrated, light passing slots are also formed on the lower surfaces of the unit cases of the process cartridges 100Y, 100C, 100M, and 100K, and on a surface of the optical writing device 4 facing the lower surfaces of the unit cases.

When the process cartridge 100 is attached to and detached from the image forming apparatus 2, if the image carrying member 1 included in the process cartridge 100 contacts and rubs the intermediate transfer belt 10, the surfaces of the image carrying member 1 and the intermediate transfer belt 10 may be scratched and damaged.

In light of the above, the image forming apparatus 2 according to the present embodiment includes the rails 54Y, 54C, 54M, and 54K, as illustrated in FIGS. 7 and 8 (not illustrated in FIGS. 1 and 2). The rails 54Y, 54C, 54M, and 54K regulate upward movement of the respective process cartridges 100Y, 100C, 100M, and 100K, when the process cartridges 100Y, 100C, 100M, and 100K are attached to and detached from the image forming apparatus 2. The rails 54Y, 54C, 54M, and 54K are formed by cutting portions of the regulation plates 52Y, 52C, 52M, and 52K which are made of metal or the like, and by bending the cut portions. Further, the rails are located at a distance from and at a higher position than the support plates.

The convex portions 55Y, 55C, 55M, and 55K are formed on the guiding surfaces of the support plates 51Y, 51C, 51M, and 51K which guide the lower surfaces of the respective process cartridges 100Y, 100C, 100M, and 100K.

The reference holes 56Y and 56C shown in FIG. 8 are formed on the regulation plates 52Y and 52C, respectively. Although not illustrated in FIG. 8, reference holes 56M and 56K are similarly formed in the regulation plates 52M and 52K, respectively.

The process cartridges 100Y, 100C, 100M, and 100K are pulled out from the image forming apparatus 2 in a direction indicated by an arrow “F” and pushed into the image forming apparatus 2 in a direction indicated by an arrow “E” shown in FIG. 7. When the process cartridge 100 is pulled out from and pushed into the image forming apparatus 2, the lower surface of the unit case 101 of the process cartridge 100 is guided by the support plate 51. Further, as illustrated in FIG. 10, a side surface of the unit case 101 of the process cartridge 100 comes in contact with the regulation plate 52 by the weight of the process cartridge 100. In this manner, the process cartridge 100 is smoothly attached to and detached from the image forming apparatus 2 by the guiding member 50 without being misaligned in a width direction indicated by an arrow “G” shown in FIG. 10 (i.e., a direction perpendicular to a longitudinal direction of the process cartridge 100).

FIG. 9 illustrates an exterior of the process cartridge 100. An engaging portion 102 formed by a convex piece is provided to protrude from a leading end side of a side surface of the unit case 101 (i.e., a side of the process cartridge 100 which comes to a backside of the image forming apparatus 2 when the process cartridge 100 is attached to the image forming apparatus 2). Meanwhile, a reference convex portion 103 is provided at a front side of the side surface of the unit case 101 to engage with the reference hole 56. Further, a lever 104 is provided on a front surface of the unit case 101.

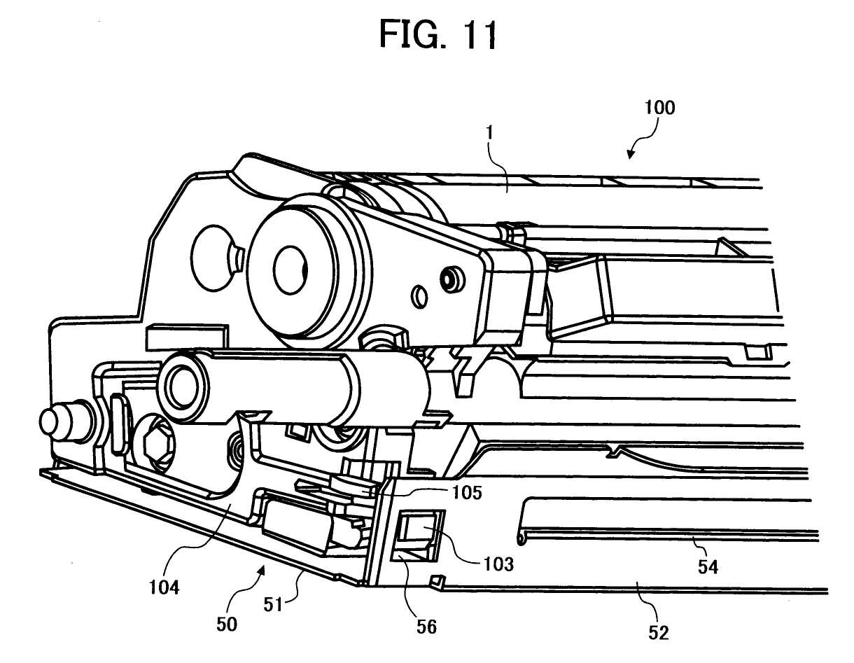

When the process cartridge 100 is pushed along the guiding member 50 to be attached to the image forming apparatus 2, the engaging portion 102 of the process cartridge 100 engages with a lower surface of the rail 54 shown in FIG. 11. Similarly, the engaging portion 102 engages with the lower surface of the rail 54, when the process cartridge 100 is pulled out of the image forming apparatus 2. With the engaging portion 102 thus engaged with the rail 54, the process cartridge 100 is prevented from moving upward when attached to and detached from the image forming apparatus 2. As a result, the image carrying member 1 included in the process cartridge 100 is prevented from contacting and scratching the surface of the intermediate transfer belt 10.

As illustrated in FIG. 7, a length of the rail 54 is made shorter than a length of the support plate 51 in directions indicated by the arrows “E” and “F.” Therefore, when the process cartridge 100 is inserted partway into the image forming apparatus 2, the protruding engaging portion 102 of the process cartridge 100 slides out of the plate-shaped rail. With this configuration, after having been inserted into a predetermined position in the image forming apparatus 2, the process cartridge 100 can move upward so that the image carrying member 1 included in the process cartridge 100 contacts the intermediate transfer belt 10. Accordingly, when the process cartridge 100 is attached to the image forming apparatus 2, the upward movement of the process cartridge 100 can be regulated by the rail 54.

To prevent the process cartridge 100 from contacting the intermediate transfer belt 10, it is desirable to make the process cartridge 100 retracted as far away as possible from the intermediate transfer belt 10 when the process cartridge 100 is attached to the image forming apparatus 2. The process cartridge 100, however, should be moved toward the intermediate transfer belt 10 to be set to a predetermined position. As illustrated in FIG. 7, according to the present embodiment, therefore, the protruding portion 55 is provided in a backside area of the guiding member 50 to protrude upward from the guiding surface of the guiding member 50. With the protruding portion 55 thus configured, when the process cartridge 100 is inserted in the image forming apparatus 2 and the engaging portion 102 of the process cartridge 100 slides out of the rail 54, the process cartridge 100 moves on the protruding portion 55. Then, the process cartridge 100 is raised upward, and the image carrying member 1 included in the process cartridge 100 comes in contact with the intermediate transfer belt 10.

FIG. 11 illustrates a perspective view of parts of the process cartridge 100 installed in the image forming apparatus 2. When the process cartridge 100 is pushed into and attached to the image forming apparatus 2, the process cartridge 100 needs to be appropriately set to a predetermined position in the image forming apparatus 2. As illustrated in FIG. 11, according to the present embodiment, therefore, the reference hole 56 is formed on a front side of the regulation plate 52 which is made of a metal, for example. Further, as illustrated in FIGS. 9 and 11, a reference part including the reference convex portion 103 is provided on the front side of the unit case 101 of the process cartridge 100.

As illustrated in FIG. 11, when the process cartridge 100 is inserted to a backmost position in the image forming apparatus 2, the reference convex portion 103 formed on the process cartridge 100 fits in and engages with the reference hole 56 by the weight of the process cartridge 100. As a result, the process cartridge 100 is appropriately positioned in the image forming apparatus 2 in the longitudinal direction of the process cartridge 100. The process cartridge 100 is biased by a biasing device (not illustrated), such as a compression spring from the backside of the image forming apparatus 2. Therefore, the process cartridge 100 is set to the predetermined position in the longitudinal direction of the process cartridge 100 and locked at the predetermined position.

With the configuration as described above, the process cartridge 100 can be fully positioned. Alternatively, the process cartridge 100 may be fully positioned by moving an adjusting plate (not illustrated), which can be attached to and detached from the image forming apparatus 2, to a closing position. Still alternatively, the process cartridge 100 may be fully positioned by engaging a pin (not illustrated) provided on the backside of the process cartridge 100 with a reference hole (not illustrated) formed on a backside surface of the image forming apparatus 2.

When the process cartridge 100 is detached from the image forming apparatus 2, the reference convex portion 103 of the process cartridge 100 is released from the reference hole 56 so that the process cartridge 100 is released from the predetermined position in the longitudinal direction of the process cartridge 100, at which the process cartridge 100 is locked. Then, the process cartridge 100 is pulled out toward the front side of the image forming apparatus 2. The process cartridge 100 can be desirably released from the lock position with a configuration described below.

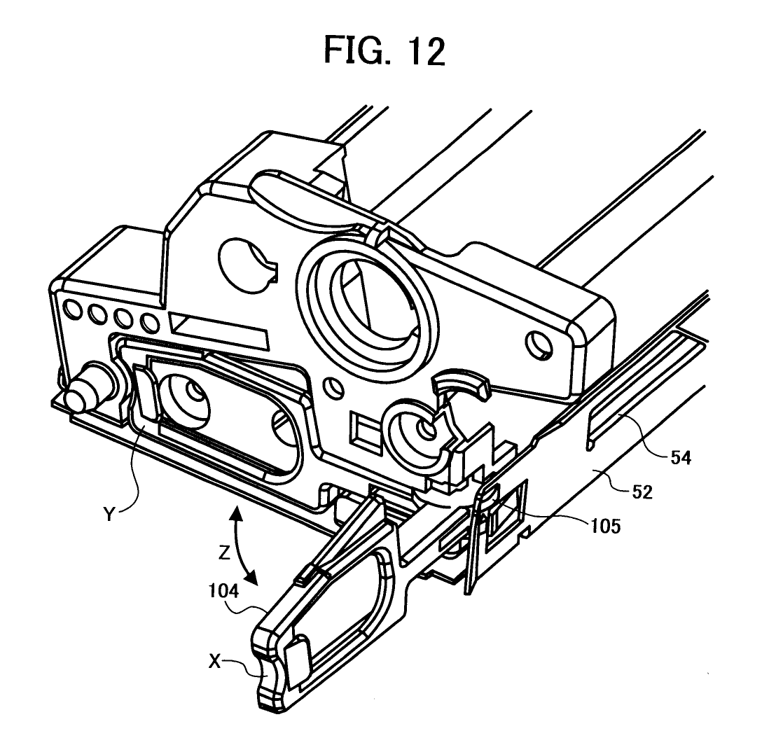

As illustrated in FIGS. 10 through 12, the lever 104 is provided at the front side of the unit case 101 of the process cartridge 100. As illustrated in FIG. 12, the lever 104 is connected to the unit case 101 to move between a working position X and a storing position Y along the path indicated by arrows “Z.” The lever 104 in the storing position is illustrated in FIGS. 10 and 11.

The lever 104 is in the storing position Y when the process cartridge 100 is attached to the image forming apparatus 2 and is being used. When the process cartridge 100 is taken from the image forming apparatus 2, the lever 104 is moved from the storing position Y to the working position X shown in FIG. 12. Then, a cam portion 105 provided on a base end of the lever 104 contacts and presses the regulation plate 52. Reaction force from the regulation plate 52 slightly moves the process cartridge 100 in a direction of separating from the regulation plate 52. As a result, the reference convex portion 103 of the process cartridge 100 is released from the reference hole 56. After that, the lever 104 is pulled out to the front side of the image forming apparatus 2.

According to the present embodiment, the above-described image forming apparatus is configured to include the transfer member, i.e., the intermediate transfer belt, on which toner images formed on the respective image carrying members are transferred. Alternatively, the image forming apparatus may be configured such that the toner images formed on the respective image carrying members are directly transferred to a recording medium, which also serves as a transfer member on which toner images of different colors formed on the image carrying members are transferred. Still alternatively, the image forming apparatus may be configured to include a single process cartridge.

Further, the above-described image forming apparatus according to the present embodiment is configured to include the process cartridges each including the image carrying member. Alternatively, the image forming apparatus may be configured to include the process cartridges each including the development device but not the image carrying member. In this case, the image carrying member may be housed in another unit which is detachably provided in the image forming apparatus.

The image forming apparatus according to the present embodiment can be a color image forming apparatus according to an electrographic system.

The above-described embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of this patent specification may be practiced otherwise than as specifically described herein.

1. An image forming apparatus comprising:
a plurality of process cartridges each including
an image carrying member; and
an image forming device configured to form a toner image on the image carrying member;
a plurality of guiding members each having a plane support surface to support and guide a plane bottom of a unit case of a corresponding process cartridge of the plurality of process cartridges when the corresponding process cartridge is attached to and detached from the image forming apparatus body, each plane support surface being arranged with a slant in a direction perpendicular to an attachment and detachment direction of the corresponding process cartridge so that each plane support surface has a different height-wise position than other plane support surfaces the plurality of guiding members;
a plurality of regulation elements configured to prevent the corresponding process cartridge from displacing in a direction perpendicular to the attachment and detachment direction of the corresponding process cartridge, each regulation element has a regulation plate which protrudes from a corresponding support surface, the regulation plate being configured to support a side of the corresponding process cartridge which, by its weight, has been brought into contact with the regulation plate so as to prevent the corresponding process cartridge from displacing in the widthwise direction; and
a convex portion extending from each support surface provided at a backside portion of each support surface in the attachment and detachment direction of the corresponding process cartridge,
wherein toner images different in color formed on each image carrying member are transferred to a transfer material to thus form a recorded image, the process cartridges are each provided in a vertically slanted direction and detachable from the image carrying member in an axial direction of the image carrying member, and each process cartridge mounts to a corresponding convex portion and is fixedly positioned when each process cartridge is pushed into the image forming apparatus body.

2. The image forming apparatus as claimed in claim 1, wherein each guiding member includes a light passing slot through which a corresponding laser beam passes so that the corresponding laser beam emitted from an optical writing device can reach each corresponding image carrying member, and each convex portion is provided between a corresponding light passing slot and a corresponding regulation plate.

3. The image forming apparatus as claimed in claim 1, wherein a reference hole is formed in each regulation plate and a reference convex portion is provided in each unit case of each process cartridge, and each reference convex portion engages with each corresponding reference hole so that each process cartridge is positioned fixedly along a longitudinal direction of the process cartridge when each process cartridge is pushed into a most backside portion of the image forming apparatus.

4. The image forming apparatus as claimed in claim 3, wherein each process cartridge further comprises:
a lever provided pivotally and moving between a storing position and a working position,
wherein when the lever is moved pivotally to the working portion, a cam portion provided at a base end of the lever contacts the regulation plate of the process cartridge so that the process cartridge is moved to a direction separating from the regulation plate and the reference convex portion disengages from the reference hole.

5. The image forming apparatus as claimed in claim 1, wherein each regulation plate further includes a guiding member configured to regulate upward movement of each corresponding process cartridge.

6. The image forming apparatus as claimed in claim 5, wherein each guiding member is formed by cutting each regulation plate and by bending the cut portions, each regulation plate being a metal plate.

7. The image forming apparatus as claimed in claim 5, wherein each guiding member is configured to regulate the upward movement of each corresponding process cartridge halfway when each corresponding process cartridge is mounted into the image forming apparatus body, and a convex portion protruding upward from each corresponding support surface is provided at a further backside portion of each support surface in the process cartridge attachment and detachment direction.
